(19) United States
(12) Patent Application Publication
(10) Pub. No.: US 2015/0309601 A1
(43) Pub. Date: Oct. 29, 2015

(54) TOUCH INPUT SYSTEM AND INPUT CONTROL METHOD

(71) Applicant: Shimane Prefectural Government, Matsue-shi (JP)

(72) Inventors: Kenji Izumi, Matsue-shi (JP); Yuji Shinomura, Matsue-shi (JP)

(73) Assignee: Shimane Prefectural Government, Matsue-shi (JP)

(21) Appl. No.: 14/263,099

(22) Filed: Apr. 28, 2014

(51) Int. Cl. G06F 3/041

(52) U.S. Cl. CPC G06F 3/041

(57) ABSTRACT

A touch input system has an operation input device having a sensor and a CPU. The CPU is configured to display a mark as a selection object on a display based on a first touch operation. The CPU is further configured to determine an operation mode of a series of touch operations including the first touch operation and the second touch operation. In determining, the CPU is configured to classify the touch operations into any of groups of first touch operations and second touch operations based on a time difference between the touch operations detected.

### BACKGROUND OF THE INVENTION

1. Field of the Invention

The present invention relates to a touch input system and an input control method, and more particularly, to a touch input system and input control method for performing a touch operation with a finger.

2. Description of the Related Art

Many of smartphones are typically provided with a touch panel to realize a touch operation by a user, and when a finger is released from the touch panel, a click operation or a double-click operation is determined. As a device with a touch panel, for example, an input device of Japanese Patent Laid-Open No. 2012-173749 is disclosed.

### SUMMARY OF THE INVENTION

However, if the click operation or the double-click operation is determined when the finger used for the touch operation is released from the touch panel, operation content may be erroneously determined depending on the situation because the finger may be released by accident.

Also, in the input device of Japanese Patent Laid-Open No. 2012-173749, a touch panel is configured integrally with a display unit, and therefore there is a problem that the touch panel has to be used integrally with the display unit at any time.

In view of the above, it is an object of the present invention to provide a touch input system and input control method, whereby a multi-touch operation can be made using a touch sensor without a display function and an appropriate touch operation can be made based on a user's decision instruction.

A touch input system for solving the aforementioned problem includes: a display part; at least one operation input unit for receiving a touch operation, the at least one operation input unit having a sensor and; a display control part for displaying a mark as a selection object on the display part based on a first touch operation, the first touch operation being first detected based on a signal from the sensor; an operation mode determination part, when in a state where the first touch operation is detected a second touch operation following the first touch operation is detected, for determining an operation mode of a series of touch operations including the first touch operation and the second touch operation; and an input operation for performing part for performing an input process corresponding to the operation mode, and wherein the operation mode determination part classifies the touch operations into any of groups of first touch operations and second touch operations based on a time difference between the touch operations detected, and determines the touch operations.

Here, the aforementioned operation mode determination part may determine the operation mode on the basis of a correspondence relationship between the first touch operation and the second touch operation.

Alternatively, the aforementioned operation mode may include at least one of a click operation, a double-click operation, a zoom in/out operation, a drag operation, a flip operation, a scroll operation, a swipe operation, and a rotating operation.

When the aforementioned operation input unit has two operation input units, display areas on a right side and a left side of the display part may be preliminarily related to each operation input unit, and the display area on the right side and the left side may be set as a selection screen area in the order in which a touch first occurs.

An input control method performed by a computer for solving the aforementioned problem includes: displaying a mark as a selection object on a display part based on a first touch operation that is first detected on a basis of a signal from a sensor provided in an operation input unit; when, in a state where the first touch operation is detected, a second touch operation following the first touch operation is detected, determining an operation mode of a series of touch operations including the first touch operation and the second touch operation; and performing an input process corresponding to the operation mode, and wherein the determining includes classifying the touch operations into any of groups of first touch operations and second touch operations based on a time difference between the touch operations detected, and determining the touch operations.

Further, a program for solving the aforementioned problem is a program for causing a computer to perform the aforementioned input control method.

According to the present invention, a multi-touch operation can be made using a touch sensor without a display function and an appropriate touch operation can be made based on a user's decision instruction.

Further features of the present invention will become apparent from the following description of exemplary embodiments with reference to the attached drawings.

### BRIEF DESCRIPTION OF THE DRAWINGS

FIG. 1 is diagram showing an example of a hardware configuration of a touch input system according to a first embodiment;

FIG. 2A is a diagram showing an example of an appearance of an operation input unit;

FIG. 2B is a diagram showing the example of the appearance of the operation input unit;

FIG. 3A is a diagram showing a usage mode of the operation input unit;

FIG. 3B is a diagram showing a usage mode of the operation input unit;

FIG. 4 is a timing chart showing an example of a first touch operation, a second touch operation and operation images;

FIG. 5 is a diagram showing an example of an operation mode;

FIG. 6A is a diagram showing an example of a touch operation;

FIG. 6B is a diagram showing an example of a touch operation;

FIG. 6C is a diagram showing an example of a touch operation;

FIG. 6D is a diagram showing an example of a touch operation;

FIG. 7 is a diagram showing an example of a functional configuration of the touch input system according to the first embodiment;

FIG. 8 is a flowchart showing an outline of an example of the overall actions of the touch input system in the first embodiment;

FIG. 9 is a flowchart for explaining an input process of the first embodiment in detail;

FIG. 10 is a diagram showing a usage mode in the case where a user performs touch operations with one hand;

FIG. 11 is a diagram for explaining a correspondence relationship between an operation area of a first operation input unit and display areas of a display part in a touch input system of a variation 2;

FIG. 12 is a diagram for explaining a correspondence relationship between an operation area of a second operation input unit and display areas of the display part in the touch input system of the variation 2;

FIG. 13 is a diagram for explaining a correspondence relationship between operation areas of two operation input units and a display area of a display part realized by a touch input system of a variation 3;

FIG. 14 is a diagram showing usage modes of a touch input system of a variation 4, which is adapted to be able to perform a touch operation on keyboard screens displayed on a display device;

FIG. 15 is a diagram for explaining a mode where a user sits on a sofa using the operation input unit; and

FIG. 16 is a diagram for explaining a usage mode of the operation input unit.

### DESCRIPTION OF THE EMBODIMENTS

### First Embodiment

Explanation will be hereinafter made for a first embodiment of a touch input system of the present invention. The touch input system (hereinafter referred to as an input system) 1 is a system that receives a touch operation performed with a finger.

### [Configuration of Input System 1]

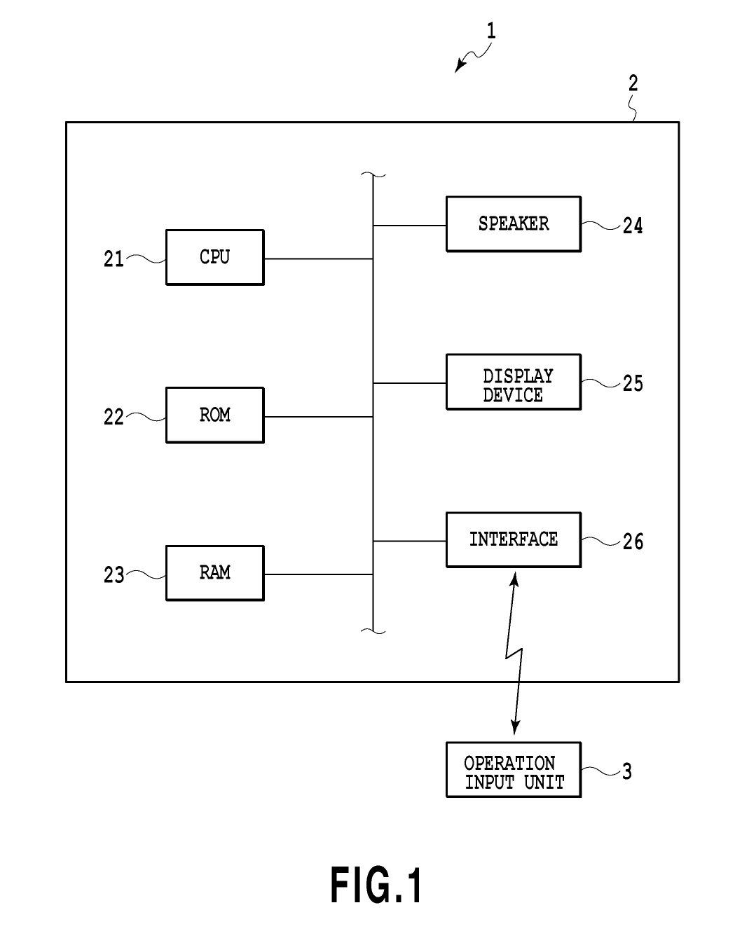

FIG. 1 is a diagram showing an example of a hardware configuration of the input system 1 according to the first embodiment of the present invention. As illustrated in FIG. 1, the input system 1 is provided with a main body unit 2 and an operation input unit 3. The main body unit 2 has a CPU (Central Processing Unit) 21, ROM (Read Only Memory) 22, RAM (Random Access Memory) 23, speaker 24, display device 25 and interface 26.

The CPU 21 is connected to the respective components through a bus to perform a transfer process of a control signal or data, as well as executing various types of programs for realizing the overall actions of the input system 1 and performing processes such as an arithmetic process.

The ROM 22 is recorded with the programs and data necessary for the overall actions of the input system 1. The programs are stored in a recording medium such as a DVD-ROM, and read in the RAM 23 to start the execution by the CPU 21, and thereby the input system 1 of the present embodiment is realized.

The RAM 23 temporarily retains data or a program.

The speaker 24 outputs sound corresponding to sound data generated by the CPU 21, such as data on a sound effect.

The display device 25 can be a flat panel display such as a liquid crystal display or an EL (Electro-Luminescence) display.

The operation input unit 3 connected to the interface 26 is provided with a sensor adapted to, when inputting information, detect a touch operation performed by a user, and the output of the sensor is transmitted to the CPU 21 through the interface 26 and then processed. This embodiment is configured to connect the interface 26 and the operation input unit 3 to each other wirelessly; however, a wired configuration is also possible. In this embodiment, a user places a finger on the operation input unit 3 to move a corresponding mark such as a cursor on a display screen of the display device 25, and thereby operates the main body unit 2; however, as long as such an operation is available, any system can be employed as a configuration of the operation input unit 3.

The operation input unit 3 has, for example, a touch panel and the like. The sensor provided in the operation input unit 3 is, for example, a pressure sensor adapted to detect a user's touch on the operation input unit 3. Alternatively, the sensor of the present embodiment is, for example, a multi-touch sensor, and in such a case, it is not necessary to, like a track pad, separately provide a hardware structure such as a button.

As the above-described mark, an icon, a pointer, a cursor, or the like may be employed.

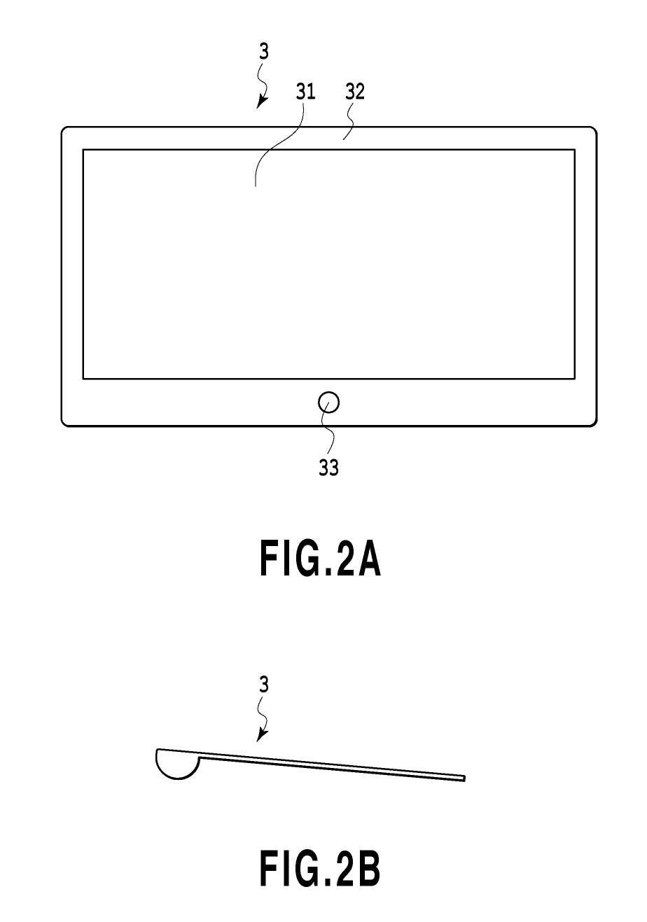

FIG. 2 is a diagram showing an example of an appearance of the operation input unit 3, in which A shows a top view of the operation input unit 3, and B shows a side view of the operation input unit 3. The operation input unit 3 illustrated in FIG. 2A is configured to include an operation surface 31 mounted with the above-described sensor, and an outer frame 32, and when a finger touches the operation surface 31, the touch is detected by the sensor.

A menu button 33 plays a role in switching between an input operation through a software keyboard and an input operation through a mark such as a cursor. Note that the present invention may be adapted to switch between the input operations with a preset touch operation (such as a touch operation with five fingers).

The operation input unit 3 is configured to be user-friendly by, as illustrated in FIG. 2B, providing a tilt so as to make a front side lower and a rear side higher as viewed from a user.

### [Outline of Touch Operation]

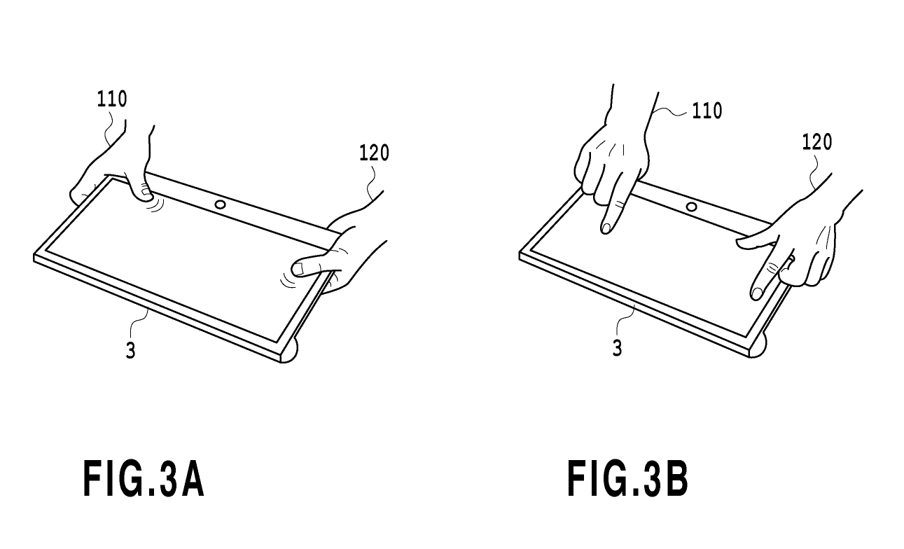

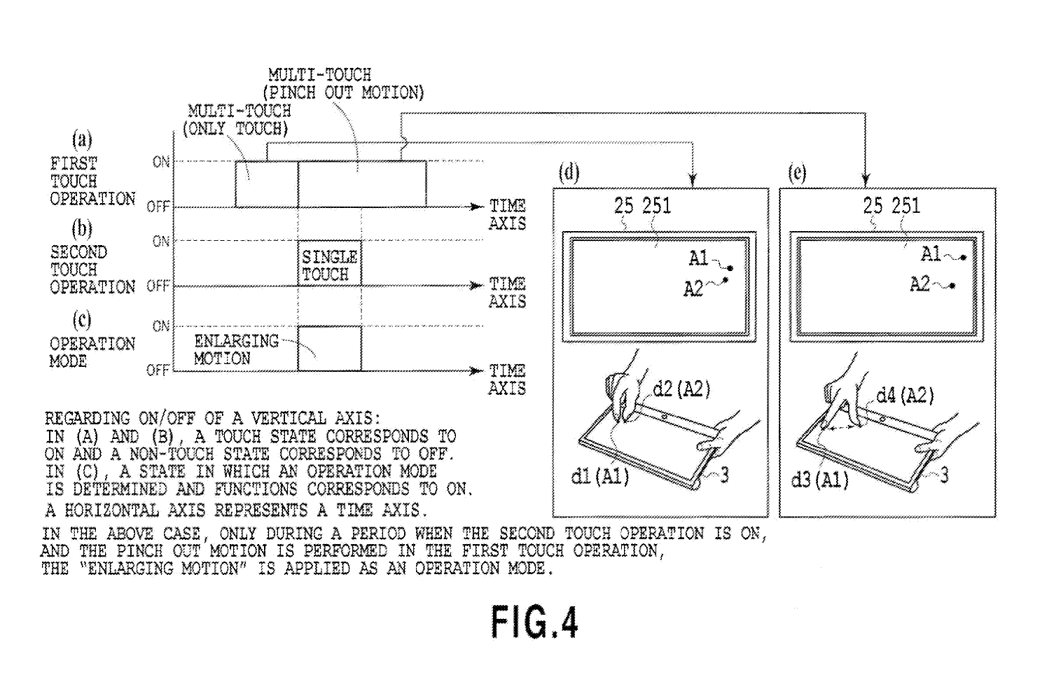

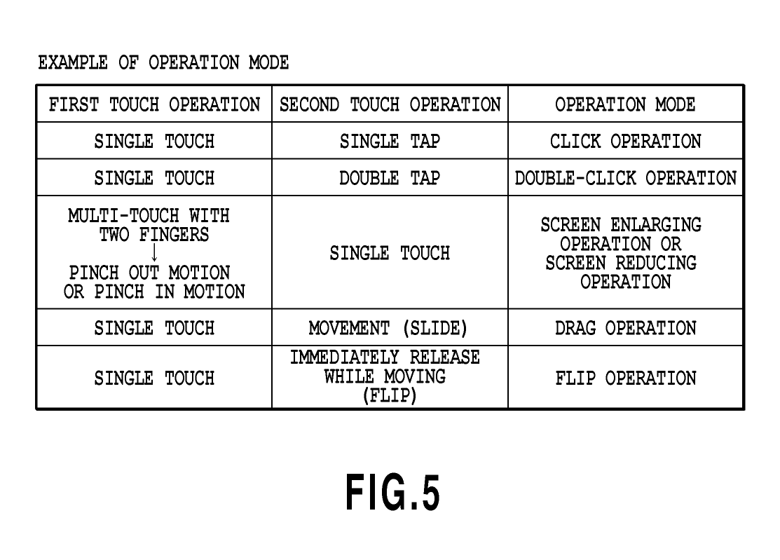

Next, the outline of the touch operation realized by the input system 1 is described with reference to FIGS. 3, 4 and 5. FIG. 3 is a diagram showing an example of usage modes of the touch operation through the operation input unit 3, in which A illustrates the case of performing the touch operation only with the thumbs of both hands 110 and 120, and B illustrates the case of performing the touch operation with the forefinger of the right hand 110 and the forefinger and thumb of the left hand 120. FIG. 4 is a timing chart showing an example of a first touch operation, a second touch operation, and operation images. FIG. 5 is a diagram showing an example of an operation mode.

For example, as illustrated in FIG. 3A or 3B, a user touches the operation input unit 3 with the one fingers of the both hands 110 and 120, or with the one finger of the right hand 110 and the two fingers of the left hand 120, and thereby the sensor of the operation input unit 3 detects the touch operations by the user. For example, FIGS. 4A to 4E illustrate an example where a user gets a touch with two fingers (forefinger and thumb) of the right hand, and then gets a touch with one finger (thumb) of the left hand (second touch operation), as well as performing a pinch out motion of spreading the two fingers of the right hand (first touch operation), whereby an operation mode of a screen enlarging action (FIG. 4C) corresponding to the pinch out motion is fixed, and the display screen of the display device 25 is enlarged. In this case, referring to the operation images in FIGS. 4D and 4E, the CPU 21 displays respective marks A1 and A2 at positions in a display area 251 of the display device 25, which correspond to positions (d1→d3, d2→d4) at which the respective fingers touch the operation input unit 3.

Note that in this embodiment, the marks A1 and A2 are displayed in response to the first touch operation; however, the present invention may be adapted to delete all the marks A1 and A2 collectively at the time of performing the second touch operation.

In the input system 1, the CPU 21 determines the operation mode of the series of touch operations including the first touch operation and the second touch operation by, for example, referring to operation mode patterns illustrated in FIG. 5. These patterns are recorded in the ROM 22, and when performing a tap operation on the input system 1, a corresponding pattern is read from the ROM 22.

As FIG. 5 illustrates the example, each of the operation modes is preliminarily related to respective operation contents of the first and second touch operations. Note that the first touch operation and the second touch operation are performed with different fingers, respectively, and the second touch operation is performed in the case where the first touch operation is performed.

In FIG. 5, for example, in the case where the first touch operation is a “single touch” performed with one finger, and the second touch operation is a “single tap”, the operation mode is set as a “click operation”, whereas in the case where the first touch operation is a “single touch”, and the second touch operation is a “double tap”, the operation mode is set as a “double-click operation”. A tap operation may be performed with one or more fingers.

Also, in FIG. 5, in the case where the first touch operation is a multi-touch “pinch out motion or pinch in motion” performed with two fingers, and the second touch operation is a “single touch”, the operation mode is set as a “screen enlarging/reducing operation” (see FIG. 4 for the enlarging operation). In the case where the first touch operation is a “single touch”, and the second touch operation is a “slide” that moves fingers (regardless of the number of fingers), the operation mode is set as a “drag operation”. In the case where the first touch operation is a “single touch”, and the second touch operation is a “flip” that, while moving a finger after a touch, immediately release the finger, the operation mode is set as a “flip operation”.

Note that a correspondence relationship between the first touch operation and the second touch operation is not limited to any of those exemplified in FIG. 5. For the correspondence relationship, various settings are possible. For example, for the operation mode of the “screen enlarging/reducing operation”, a correspondence relationship between the first touch operation (single touch) and the second touch operation (pinch out or pinch in motion performed with two fingers) may be set.

Also, for the case where the operation mode is the “drag operation”, a correspondence relationship between the first touch operation (single touch), and after the second touch operation (single touch or multi-touch), dragging performed with a finger used in the first touch operation for the single touch may be set.

Further, for the case where the operation mode is the “flip operation”, a correspondence relationship between the first touch operation (single touch), and after the second touch operation (single touch or multi-touch), a flip performed with a finger used in the first touch operation for the single touch may be set.

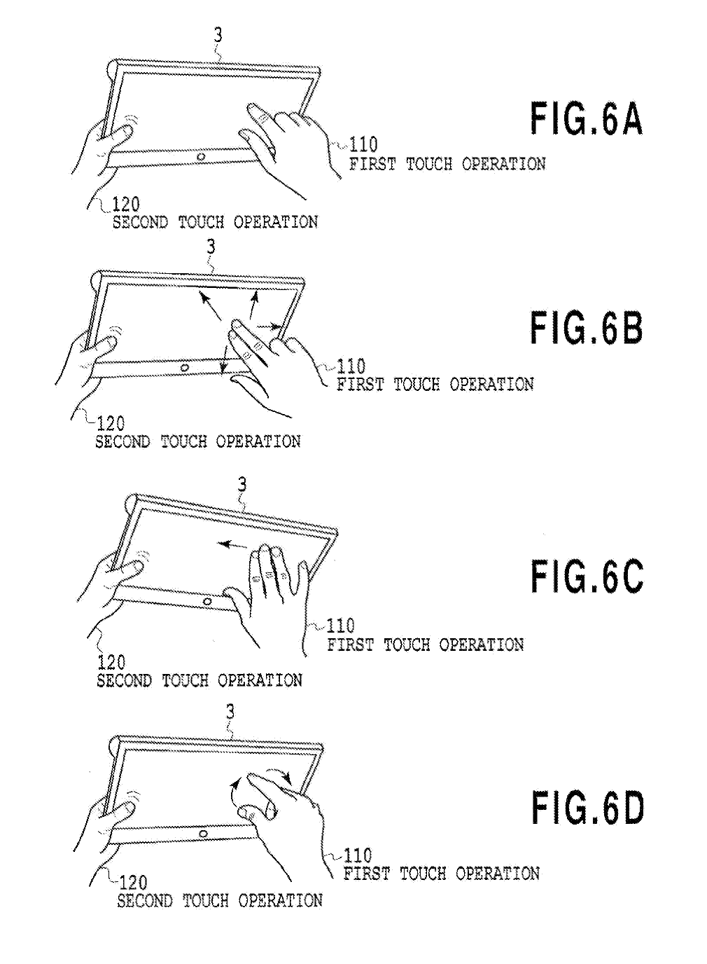

FIG. 6 is a diagram showing an example of motions corresponding to basic touch operations, in which A exemplifies a touch motion performed on the operation input unit 3 with fingers, B a slide motion that moves two fingers in an arbitrary direction, C a slide motion that moves three fingers leftward, and D a rotational motion that moves two fingers clockwise.

Each of FIGS. 6A to 6D exemplifies the case where the first touch operation is performed with one or more fingers of the right hand 110, and the second touch operation is performed with the thumb of the left hand 120.

Note that the operation surface of the operation input unit 3 is mounted with the sensor, and therefore when a finger is touched to the operation surface of the operation input part 3, the sensor detects the touch operation.

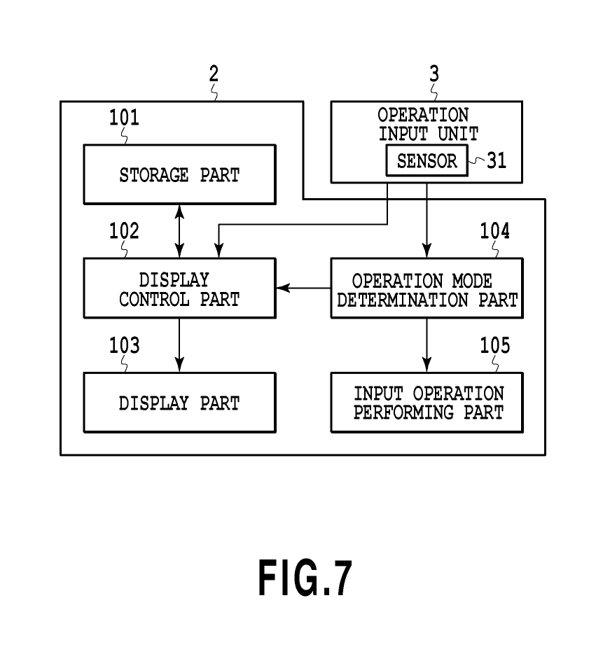

FIG. 7 is a diagram showing an example of a functional configuration of the main body unit 2 of the input system 1, which is realized in the hardware configuration illustrated in FIG. 1.

As shown in FIG. 7, the main body unit 2 of the input system 1 is provided with a storage part 101, display control part 102, display part 103, operation mode determination part 104, and input operation performing part 105.

The storage part 101 is configured to include the ROM 22 and the RAM 23 in FIG. 1, and stores data such as data on an operation mode pattern (see FIG. 5).

The display control part 102 is made to function by the CPU 21. The display control part 102 displays a mark (such as a cursor) as a selection object on the display part 103 on the basis of a first touch operation that is first detected on the basis of a signal from the sensor 31 of the operation input unit 3.

The display part 103 is configured to include the display device 25 in FIG. 1, and provided in order to make a mark viewable to a user.

In the case where in a state where the above-described first touch operation is detected, a second touch operation following the first touch operation is detected, the operation mode determination part 104 determines an operation mode of a series of touch operations including the first touch operation and the second touch operation. As the operation mode, for example, the click operation, double-click operation, screen enlarging/reducing operation, drag operation, flip operation, scroll operation, swipe operation, screen rotating operation, and the like are available. A process for determining an operation mode will be described later in detail.

The input operation performing part 105 is intended to perform an input operation corresponding to the operation mode determined by the operation mode determination part 104. In addition, the operation mode determination part 104 and the input operation performing part 105 are both made to function by the CPU 21.

### [Actions of Input System 1]

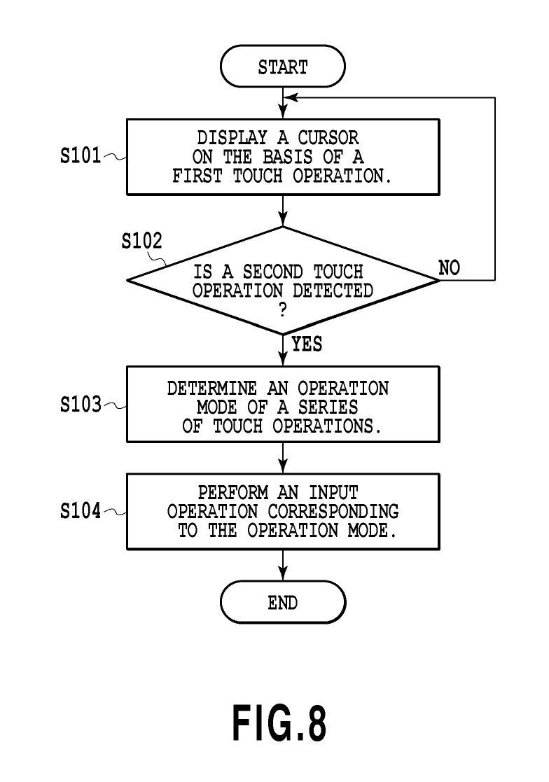

In the following, the actions of the input system 1 are described with reference to FIGS. 1, 4, 5, 8 and 9. FIG. 8 is a flowchart showing an outline of an example of the overall actions of the input system 1.

In FIG. 8, first, the CPU 21 displays, for example, a cursor as a mark in the display area 251 of the display device 25 on the basis of a first touch operation through the operation input unit 3 (Step S101). In the example of FIG. 4, the CPU 21 displays the cursors A1 and A2 at the positions in the display area 251, which correspond to the positions d1 and d2 of the two fingers touched by the first touch operation. In this case, the CPU 21 receives signals from the sensor 31 of the operation input unit 3 through the interface 26, and on the basis of the signals, determines the respective positions (d1→d3, d2→d4) of the two fingers (contact points of the two fingers in touch with the operation input unit 3). The signals from the sensor 31 include pieces of positional information respectively indicating the positions of the contact points in the touch operation with reference to the operation surface of the operation input unit 3, and the CPU 21 specifies the positions A1 and A2 in the display area of the display device 25 correspondingly to the movements of the contact points, which are detected on the basis of the signals from the sensor 31, respectively.

Note that in Step S101, the CPU 21 functions as the display control part 102.

Subsequently, in the case where in a state where the first touch operation is detected in Step 101, a second touch operation following the first touch operation is detected on the basis of a signal from the sensor 31 (Yes in Step S102), the CPU 21 determines an operation mode of a series of touch operations including the first touch operation and the second touch operation (Step S103). In this case, at the time of detecting the second touch operation, the CPU 21 refers to, for example, the operation mode patterns illustrated in FIG. 5 to determine the operation mode of the series of touch operations including the first touch operation and the second touch operation. In other words, at the time of detecting the second touch operation, the CPU 21 fixes the operation mode.

For example, in the example of FIG. 4, the CPU 21 specifies the first touch operation (after the touch with the two fingers, the pinch out operation) and the second touch operation (single touch) on the basis of the signals from the sensor 31. Then, the CPU 21 refers to the operation mode patterns (FIG. 5) to determine the operation mode as the “screen enlarging operation” from the correspondence relationship between the two touch operations.

In Steps S102 and S103, the CPU 21 functions as the operation mode determination part 104.

In addition, a time point of fixing the operation mode may be after a predetermined time has elapsed since the second touch operation was detected.

In FIG. 8, in the case where the second touch operation is not detected (No in Step S102), the CPU 21 performs a cursor display process (Step S101) based on the first touch operation.

Further, the CPU 21 performs an input operation corresponding to the operation mode (Step S104). In the example of FIG. 4, the CPU 21 determines the operation mode as the screen enlarging operation, and therefore performs a screen enlarging operation according to the pinch out operation.

Note that in Step S104, the CPU 21 functions as the input operation performing part 105.

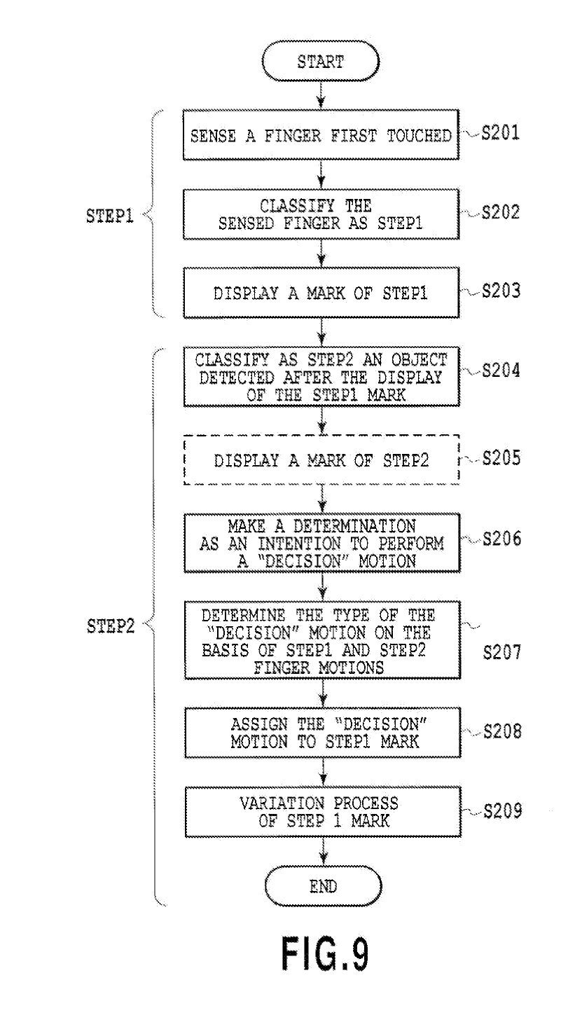

Next, with reference to FIG. 9, an input process performed in the input system 1 is more specifically described. FIG. 9 is a flowchart for explaining the input process of the present embodiment in detail.

In addition, in FIG. 9, S201, S202, S204 and S206 to S208, S203 and S205, and S209 correspond to the operation mode determination part 104, the display control part 102, and the input operation performing part 105, respectively.

In FIG. 9, illustrated as an example is the case where for S201 to S203, and S204 to S209, STEP1 and STEP2 are described as respectively different group processes.

In FIG. 9, first, on the basis of a signal from the sensor 31, the CPU 21 senses a finger first touched (Step S201), and classifies the sensed finger as STEP1 (first touch operation group) (Step S202). In this case, if a plurality of fingers is detected, touch operations performed with the plurality of fingers are all classified as the first touch operation group.

Subsequently, on the basis of the touch operation performed with the finger classified as STEP1, the CPU 21 displays a mark on the display device 25 (Step S203). An example of the display is the display of the marks A1 and A2 illustrated in FIG. 4D.

After the above-described display of the mark, in the case where on the basis of a signal from the sensor 31, the CPU 21 detects a finger touched, the CPU 21 classifies the detected finger as STEP2 (second touch operation group) (Step S204). That is, on the basis of a time difference between when touch operations were detected, the CPU 21 classifies each of the touch operations into any of a first touch operation group and a second touch operation group to make a determination. The CPU 21 can determine the time difference between the touch operations from reception times of sensing signals from the sensor 31. In this case, a time difference for making the classification into the first touch operation group and the second touch operation group is predetermined.

If in Step S204, the touch operation by the sensed finger is an operation for which a mark is to be displayed, the CPU 21 displays a mark on the display device 25 on the basis of the touch operation classified as STEP2 (Step S205). On the other hand, in the case where it is not necessary to display a mark as STEP2, a processing step in S205 is not necessary.

The CPU 21 determines that as a result of detecting the touch of the finger in Step S203, a user intends to perform a motion of a “decision” to fix the content of the touch operation (Step S206), and determines the type of the “decision” motion by the fingers respectively classified as STEP1 and STEP2 (Step S207). When performing Step S207, a corresponding operation mode is extracted from the operation mode patterns exemplified in FIG. 5.

After that, the CPU 21 assigns the above “decision” motion to the STEP1 mark (Step S208) to perform a variation process of the STEP1 mark (Step S209). Note that, in Step S208, for example, in the case where a “decision” motion indicating a screen enlarging motion is assigned, the CPU 21 moves STEP1 marks according to movements of fingers classified as STEP1, which are performed for the enlarging motion (see the marks A1 and A2 in FIG. 4E).

As described above, according to the input system 1 of the present embodiment, a user performs a first touch operation and a second touch operation, and as a result, an operation mode corresponding to the series of touch operations determined as different operations on the basis of a time difference between the touches is determined to perform an input operation corresponding to the operation mode. Note that in order for the operation mode to be determined, the user should perform the first touch operation and the second touch operation. That is, the user should perform the second touch operation with a finger different from that used for the first touch operation. This is equivalent to, every time a second touch operation is performed, issuing a user's instruction to perform an input operation, and as a result, a correct input operation is performed.

Also, the input operation unit 3 is independently configured separately from the display device 25. That is, according to the input system 1, the touch sensor not having a display function can be used to perform a multi-touch operation.

Note that the operation input unit 3 does not have any operation part such as an operation key or an operation button. In this regard, the input system 1 has a reduced manufacturing cost. Also, a user can perform an operation while freely moving fingers without using an operation key, an operation button, or the like of the operation input unit 3, and therefore a degree of freedom of finger motions of one or both hands is increased. That is, the input system 1 is also provided with an aspect that makes an operation more intuitive.

Next, variations of the input system 1 of the present embodiment are described.

### (Variation 1)

In the above, described is the case where with reference to FIG. 4, the input operation is performed correspondingly to the touch operations with the fingers of the both hands. However, apart from this, the present invention may be adapted to perform touch operations not with both hands but with one hand.

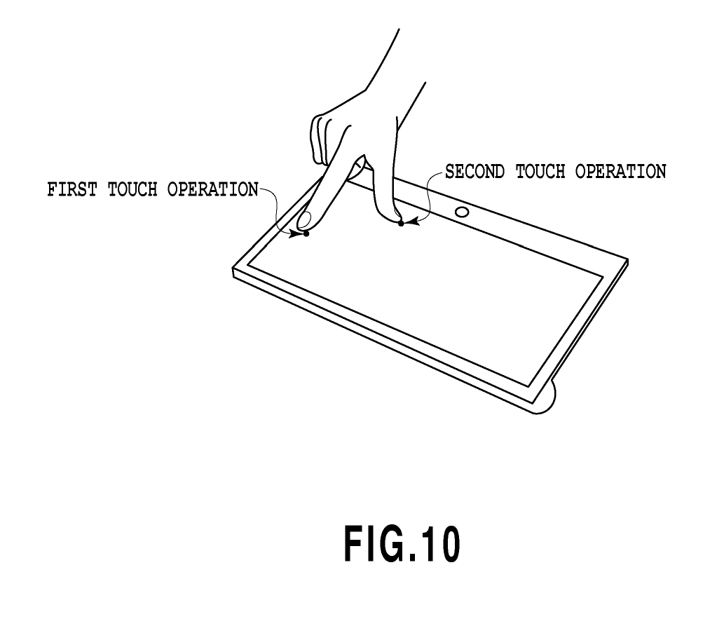

FIG. 10 is a diagram showing a usage mode in the case where a user performs touch operations with one hand. In the example illustrated in FIG. 10, a first touch operation is performed with the forefinger of the right hand, and a second touch operation is performed with the thumb of the right hand. This can be performed by performing processing in Steps S101 to S104 in the flowchart of FIG. 8 and processing in Steps S201 to S209 in the flowchart of FIG. 9.

By performing such touch operations, a series of touch operations can be performed with one hand.

### (Variation 2)

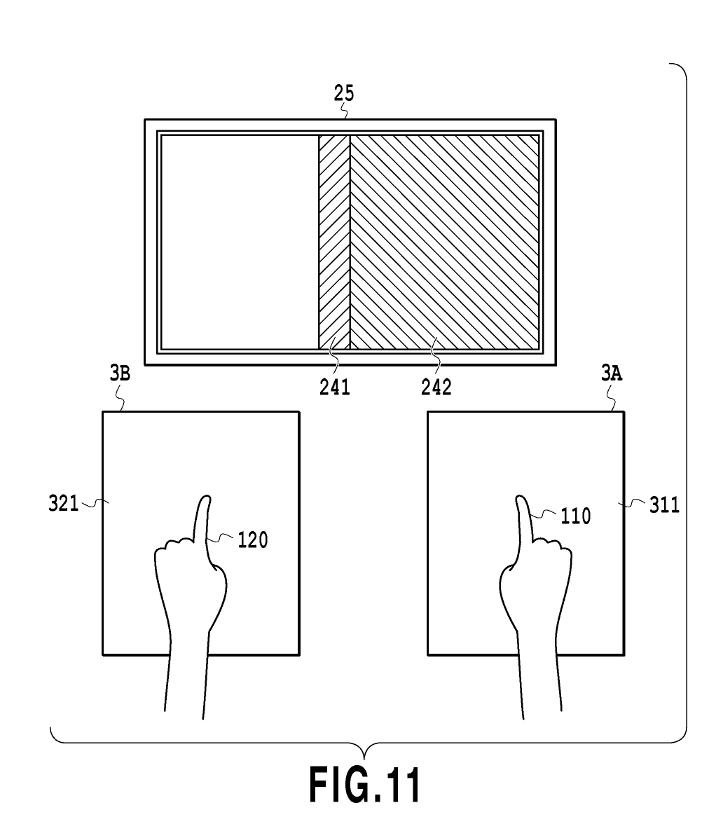

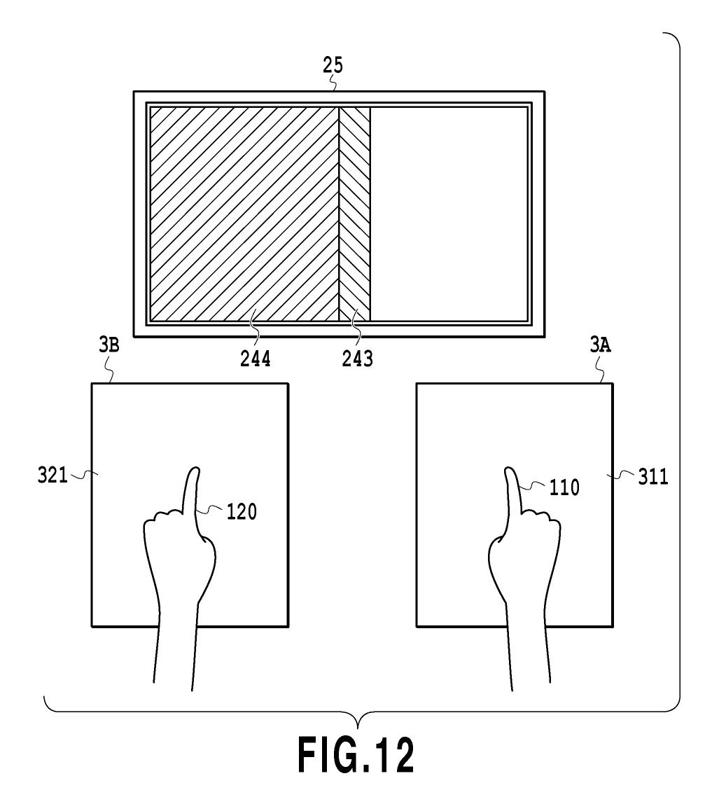

In the above, a usage mode of two operation input units is not referred to; however, the present invention may be adapted to use two operation input units. In the following, with reference to FIGS. 11 and 12, functions of operation input units 3A and 3B are described. FIG. 11 is a diagram for explaining a correspondence relationship between an operation area 311 of the operation input unit 3A and display areas 241 and 242 of a display device 25. FIG. 12 is a diagram for explaining a correspondence relationship between an operation area 321 of the operation input unit 3B and display areas 243 and 244 of the display device 25.

In the example of FIG. 11, the operation area (operation surface) 311 of the operation input unit 3A is related to the first display area 241 and the second display area 242 (also collectively referred to as a “right side display area”) of the entire display area of the display device 25. The relating is done according to, for example, a mapping table for converting pieces of coordinate data in the respective areas to each other. Note that the first display area 241 is shared by part of the below-described second display area 244.

In this input system 1, a total area of the first display area 241 and the second display area 242 are set larger than an area obtained by evenly halving the entire display area along the center line (in the diagram, indicated by a boundary line between the first display area 241 and the second display area 242) of the entire display area.

In the example of FIG. 12, the operation area (operation surface) 321 of the operation input unit 3B is related to the first display area 243 and the second display area 244 (also collectively referred to as a “left side display area”) of the entire display area of the display device 25. The relating is done according to, for example, a mapping table for converting pieces of coordinate data in the respective areas to each other. Note that the first display area 243 is shared by part of the above-described second display area 242.

In this input system 1, a total area of the first display area 243 and the second display area 244 are set larger than an area obtained by evenly halving the entire display area along the center line (in the diagram, indicated by a boundary line between the first display area 243 and the second display area 244) of the entire display area.

According to the input system of the present variation, the two operation input units 3A and 3B respectively for performing operations on the predetermined display areas are provided, and therefore an operation input unit for performing a touch operation on a corresponding display area is used. In this case, the display areas 241 to 244 of the display device 25, each of which is preliminarily related to any of the operation input units 3A and 3B, are set as a selection screen area for performing a selection operation of a mark in order on which a touch is first got. In this regard, a user can perform the selection operation with any of the left and right hands. For example, the input system can also accommodate an ambidextrous user.

For example, in the case of getting a first touch on the operation input unit 3A, the CPU 21 sets the first display areas 241 and 242 as the selection screen area.

### (Variation 3)

In an input system of a variation 3, the two input operation units 3A and 3B of the variation 2 may be used in combination.

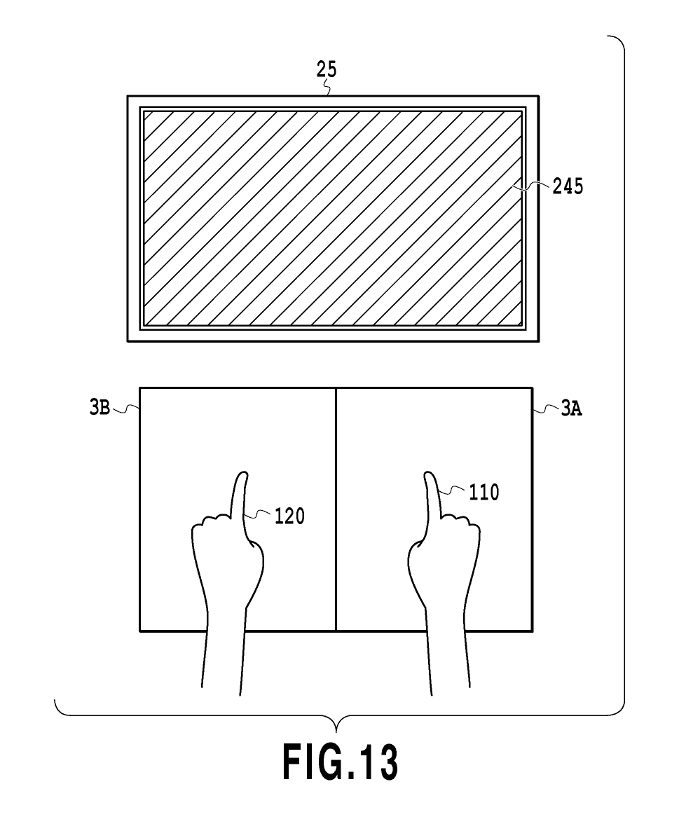

FIG. 13 is a diagram showing an example where the two input operation units 3A and 3B are used in combination. In the example of FIG. 13, the input operation units 3A and 3B are combined with each other, and the operation areas of the respective input operation units 3A and 3B are related to a display area 245 of a display device 25.

Note that in the input system of this variation, the respective operation areas of the input operation units 3A and 3B are related to the display area so as to have a one-to-one correspondence relationship.

### (Variation 4)

An input system of a variation 4 is characterized by setting keyboard screens in predetermined areas of a display screen 300, respectively, and in order to make it possible to perform a touch operation on each of the keyboard screens, relating areas of the respective keyboard screens, and an operation area of an operation input unit 3 or operation areas of respective operation input units 3A and 3B. to each other

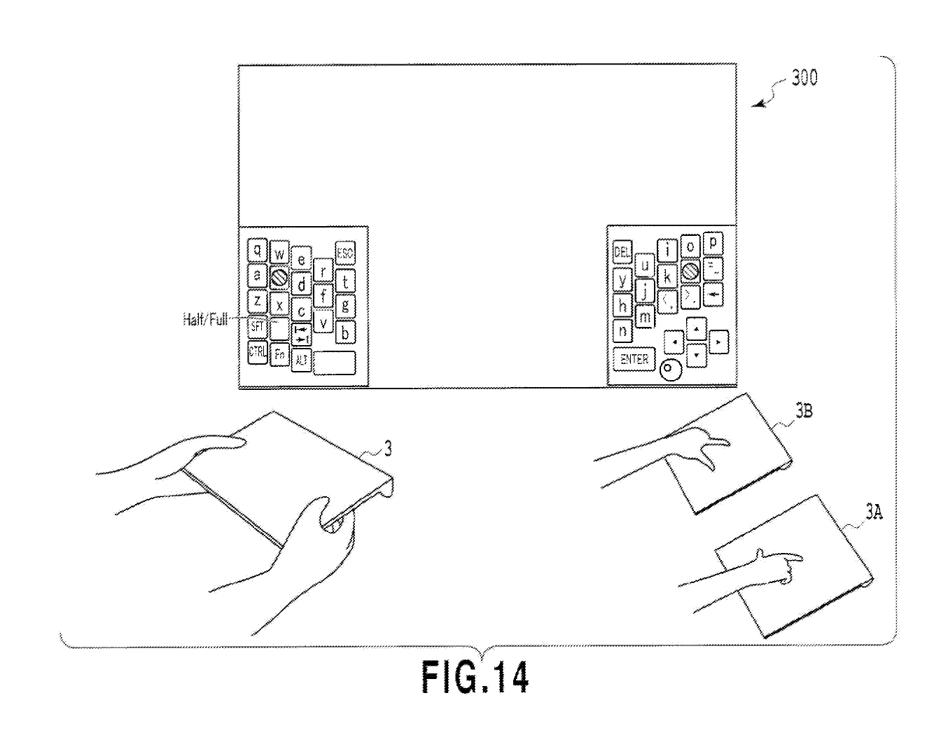

For example, FIG. 14 exemplifies usage modes of the input system that is adapted to be able to perform a touch operation on the keyboard screens displayed on a display device. In FIG. 14, the input system is configured to arrange the two keyboard screens on the display screen 300, and to be able to select data within each of the keyboard screens by, for example, touching a finger to the operation input unit 3.

Also, in the example of the operation input units 3A and 3B, the input system is configured to be able to touch a finger to each of the operation input units 3A and 3B to be able to select data within a corresponding one of the keyboard screens. This enables a user to perform a touch operation through each of the operation input units.

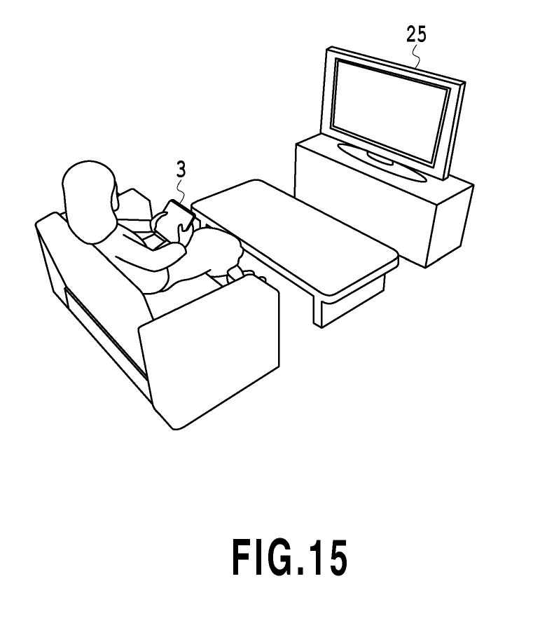

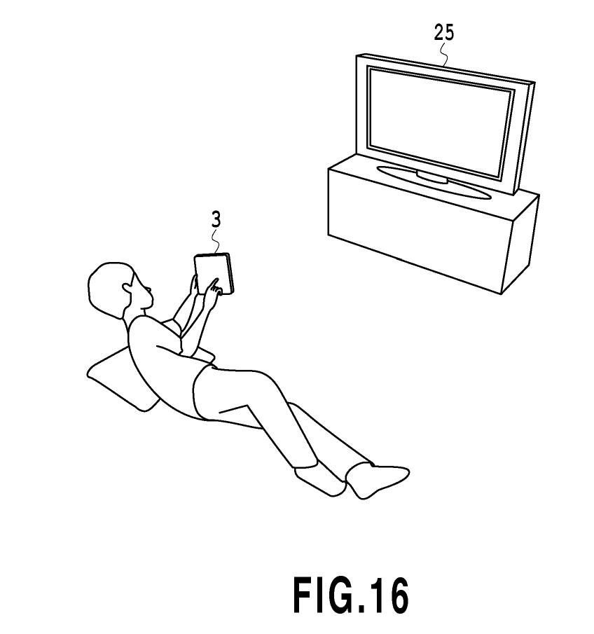

The input system may be used in various situations. For example, FIG. 15 exemplifies a mode where a user sits on a sofa using the operation input unit 3. Also, for example, FIG. 16 exemplifies another usage mode of the operation input unit 3.

(Other variations)

In the above, as an example, described with reference to FIG. 4 is the case of displaying the two marks A1 and A2 corresponding to the touch operations with the two fingers; however, the present invention is not limited to this. Even in the case of an input system using a single mark corresponding to a touch operation with one finger, or three or more marks corresponding to a touch operation with three or more fingers, the same workings and effects can be produced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A touch input system comprising:
a display part;
at least one operation input unit for receiving a touch operation, the at least one operation input unit having a sensor and;
a display control part for displaying a mark as a selection object on the display part based on a first touch operation, the first touch operation being first detected based on a signal from the sensor;
an operation mode determination part, when in a state where the first touch operation is detected a second touch operation following the first touch operation is detected, for determining an operation mode of a series of touch operations including the first touch operation and the second touch operation; and
an input operation for performing part for performing an input process corresponding to the operation mode, and
wherein the operation mode determination part classifies the touch operations into any of groups of first touch operations and second touch operations based on a time difference between the touch operations detected, and determines the touch operations.

2. The touch input system according to claim 1, wherein the operation mode determination part determines the operation mode based on a correspondence relationship between the first touch operation and the second touch operation.

3. The touch input system according to claim 1, wherein the operation mode includes at least one of a click operation, a double-click operation, a zoom in/out operation, a drag operation, a flip operation, a scroll operation, a swipe operation, and a rotating operation.

4. The touch input system according to claim 1, wherein: when the operation input unit has two operation input units, display areas on a right side and a left side of the display part preliminarily related to each operation input unit, and the display area on the right side and the left side are set as a selection screen area in the order in which a touch first occurs.

5. An input control method performed by a computer, comprising:
displaying a mark as a selection object on a display part based on a first touch operation that is first detected on a basis of a signal from a sensor provided in an operation input unit;
when, in a state where the first touch operation is detected, a second touch operation following the first touch operation is detected, determining an operation mode of a series of touch operations including the first touch operation and the second touch operation; and
performing an input process corresponding to the operation mode, and
wherein the determining includes classifying the touch operations into any of groups of first touch operations and second touch operations based on a time difference between the touch operations detected, and determining the touch operations.

6. A storage media having a program that, when executed, causes a computer to perform the following steps:
displaying a mark as a selection object on a display part based on a first touch operation that is first detected on a basis of a signal from a sensor provided in an operation input unit;
when, in a state where the first touch operation is detected, a second touch operation following the first touch operation is detected, determining an operation mode of a series of touch operations including the first touch operation and the second touch operation; and
performing an input process corresponding to the operation mode, and
wherein the determining includes classifying the touch operations into any of groups of first touch operations and second touch operations based on a time difference between the touch operations detected, and determining the touch operations.

7. The touch input system according to claim 1, wherein the operation mode includes at least one of a click operation, a double-click operation, a zoom in/out operation, a drag operation, a flip operation, a scroll operation, a swipe operation, and a rotating operation.

8. The touch input system according to claim 2, wherein: when the operation input unit has two operation input units, display areas on a right side and a left side of the display part preliminarily related to each operation input unit, and the display area on the right side and the left side are set as a selection screen area in the order in which a touch first occurs.

9. The touch input system according to claim 3, wherein: when the operation input unit has two operation input units, display areas on a right side and a left side of the display part preliminarily related to each operation input unit, and the display area on the right side and the left side are set as a selection screen area in the order in which a touch first occurs.

10. A touch input system comprising:
at least one operation input device having a sensor, the at least one operation device being configured to receive a touch operation;
at least one CPU coupled to the sensor, the CPU being configured to:
display a mark as a selection object on a display based on a first touch operation, the first touch operation being first detected based on a signal from the sensor;
determine, when in a state where the first touch operation is detected a second touch operation following the first touch operation is detected, an operation mode of a series of touch operations including the first touch operation and the second touch operation; and
perform an input process corresponding to the operation mode, and
wherein the CPU is configured to classify the touch operations into any of groups of first touch operations and second touch operations based on a time difference between the touch operations detected, and to determine the touch operations.
